(19) United States
(12) Patent Application Publication
(10) Pub. No.: US 2014/0220415 A1
(43) Pub. Date: Aug. 7, 2014

(54) BATTERY MODULE

(71) Applicants: ROBERT BOSCH GMBH, Stuttgart (DE); SAMSUNG SDI CO., LTD., Yongin-si (KR)

(72) Inventor: Young-Bin LIM, Yongin-si (KR)

(73) Assignees: ROBERT BOSCH GMBH, Stuttgart (DE); SAMSUNG SDI CO, LTD., Yongin-si (KR)

(21) Appl. No.: 14/165,801

(22) Filed: Jan. 28, 2014

(30) Foreign Application Priority Data
Feb. 5, 2013 (KR) 10-2013-0012883

(51) Int. Cl. H01M 10/653; H01M 10/42

(52) U.S. Cl. CPC H01M 10/504; H01M 10/4207
USPC 429/156

(57) ABSTRACT

A battery module includes a plurality of battery cells, each battery cell including a cap plate on an upper surface thereof, a first insulation member covering the cap plate, and a second insulation member covering side surfaces of the battery cell, the second insulation member having at least one portion contacting the first insulation member.

### CROSS-REFERENCE TO RELATED APPLICATION

This application claims priority to and the benefit of Korean Patent Application No. 10-2013-0012883, filed on Feb. 5, 2013, in the Korean Intellectual Property Office, the entire content of which is incorporated herein by reference.

### BACKGROUND

1. Field

An aspect of embodiments relates to a battery module, and more particularly, to a battery module including a battery cell provided with an insulation member of a new structure.

2. Description of the Related Art

In general, a secondary battery is a battery which can be repetitively used because it can be charged and discharged. The secondary battery may be configured with one battery cell to be used for a portable compact electronic device, e.g., a cellular phone, a notebook computer, a camera or a camcorder, or may be configured with a battery pack including a plurality of battery cells to be used as a power source, e.g., for driving a motor of a high-power hybrid electric vehicle (HEV), electric vehicle (EV), or the like.

When the battery module is used as a power source for driving a high-power motor, a large amount of heat is generated by the charging or discharging operation of the battery module. Therefore, an insulation member may be positioned between battery cells in the battery module in order to minimize deterioration thereof by the generated heat.

### SUMMARY

Embodiments provide a battery module capable of improving insulation properties.

Embodiments also provide a battery module with an insulation member in a battery cell having improved assembly efficiency, thereby improving processing efficiency and reducing production cost.

According to an aspect of embodiments, a battery module may include a plurality of battery cells, each battery cell including a cap plate on an upper surface thereof, a first insulation member covering the cap plate, and a second insulation member covering side surfaces of the battery cell, the second insulation member having at least one portion contacting the first insulation member.

The entire first insulation member may be an injection molding product.

The injection molding product may be a seamless, integral unit.

The first insulation member may include a main body portion corresponding to the cap plate of the battery cell, and a vent barrier corresponding to a vent of the battery cell.

The first insulation member may further include a terminal barrier corresponding to a terminal of the battery cell.

The second insulation member may extend higher than a height of side surfaces of the main body portion.

The first insulation member may further include an extending portion, the extending portion extending from the main body portion toward side surfaces of the battery cell and contacting the second insulation member.

The second insulation member may be a single-faced insulation tape, a double-faced insulation tape, or an insulation film.

The battery module may further include a third insulation member covering at least one contact portion between bottom and side surfaces of the battery cell, the third insulation member being between the battery cell and the second insulation member.

The third insulation member may cover the bottom surface of the battery cell.

The third insulation member may include at least one of an insulation resin, an insulation film, and an insulation coating.

The battery module may further include one or more fourth insulation members on the second insulation member, the fourth insulation member being between the second insulation member and a bottom surface of the battery cell.

The fourth insulation member may include a lower insulation member covering a contact portion between bottom and side surfaces of the battery cell, the lower insulation member being on the second insulation member.

The fourth insulation member may include a plurality of members spaced apart from each other at a predetermined interval, a connecting portion connecting the plurality of fourth insulation members.

The fourth insulation member may surround the second insulation member.

The second insulation member may extend continuously beyond side surfaces of the battery cell to overlap first insulation member on the cap plate.

The second insulation member may overlap a side surface of the cap plate and a side surface of the first insulation member.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a battery module according to a first embodiment.

FIG. 2 illustrates an exploded perspective view of the battery module in FIG. 1.

FIG. 3A illustrates a perspective view of a battery cell in FIG. 2.

FIG. 3B illustrates a sectional view taken along line A-A of FIG. 3A.

FIG. 4 illustrates a perspective view of a battery module according to a second embodiment.

FIG. 5 illustrates an exploded perspective view of the battery module in FIG. 4.

FIG. 6A illustrates a perspective view of a battery cell in FIG. 5.

FIG. 6B illustrates a sectional view taken along line B-B of FIG. 6A.

FIG. 7 illustrates a perspective view of a battery cell according to a third embodiment.

FIG. 8 illustrates a perspective view of a battery module according to a fourth embodiment.

FIG. 9 illustrates an exploded perspective view of the battery module in FIG. 8.

FIG. 10A illustrates a perspective view of a battery cell in FIG. 9.

FIG. 10B illustrates a sectional view taken along line C-C of FIG. 10A.

FIG. 11 illustrates a perspective view of a battery cell according to a fifth embodiment.

### DETAILED DESCRIPTION

Korean Patent Application No. 10-2013-0012883, filed on Feb. 5, 2013, in the Korean Intellectual Property Office, and entitled “BATTERY MODULE,” is incorporated by reference herein in its entirety.

In the following detailed description, only certain exemplary embodiments of have been shown and described, simply by way of illustration. As those skilled in the art would realize, the described embodiments may be modified in various different ways, all without departing from the inventive spirit or scope. Accordingly, the drawings and description are to be regarded as illustrative in nature and not restrictive.

In addition, when an element is referred to as being “on” another element, it may be directly on the other element or may be indirectly on the other element with one or more intervening elements interposed therebetween. Also, when an element is referred to as being “connected to” another element, it may be directly connected to the other element or may be indirectly connected to the other element with one or more intervening elements interposed therebetween. Hereinafter, like reference numerals refer to like elements throughout.

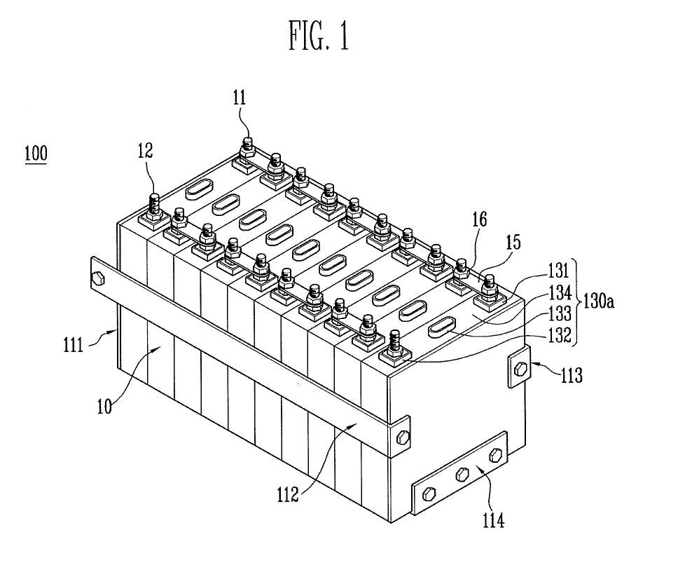

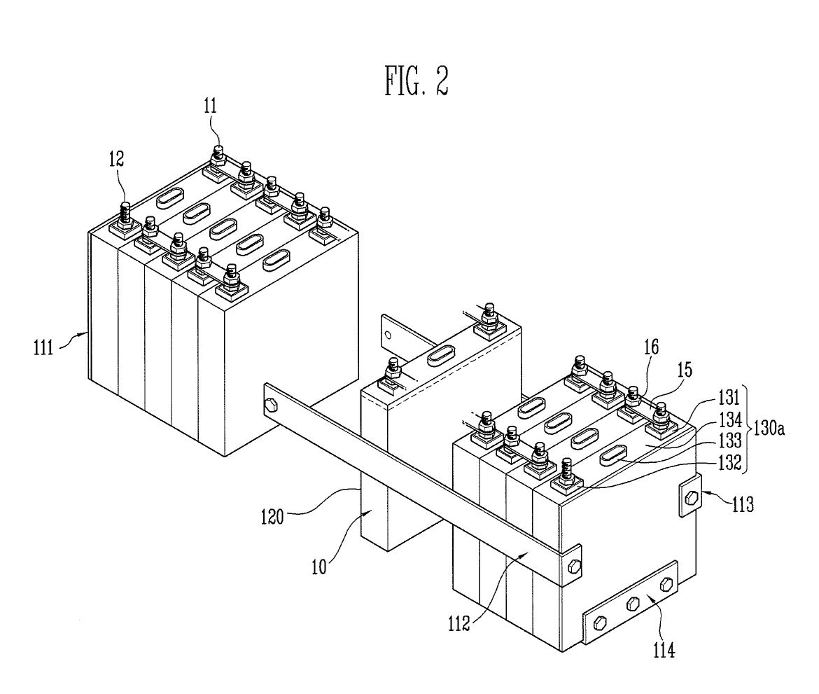

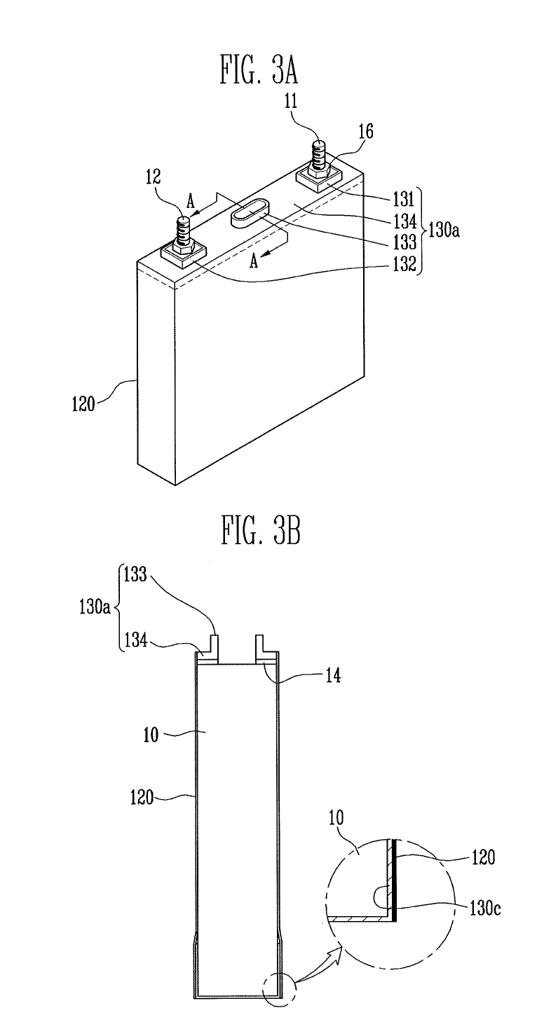

FIG. 1 is a perspective view schematically showing a battery module according to a first embodiment. FIG. 2 is an exploded perspective view of the battery module shown in FIG. 1. FIG. 3A is a perspective view of a battery cell shown in FIG. 2. FIG. 3B is a sectional view taken along line A-A of FIG. 3A.

Referring to FIGS. 1 to 3A, a battery module 100 according to the first embodiment may include a plurality of battery cells 10, each having a cap plate 14 provided on an upper surface thereof (FIG. 3B), a first insulation member 130a covering the cap plate 14, and a second insulation member 120 covering side surfaces of the battery cell 10 and having at least one portion contacting the first insulation member 130a.

The first insulation member 130a may be an injection molding product. In this case, the first insulation member 130a may be formed through insert-injection molding. The first insulation member 130a may be formed at a temperature of about 250° C. or less. Formation of the first insulation member 130a by injection molding at the above temperature may prevent or substantially minimize damage to the battery module 100, since heat having a melting temperature in injection molding is rapidly dissipated to the outside through a mold used in the injection molding.

As illustrated in FIG. 1, the first insulation member 130a may include a main body portion 134 formed to correspond to the battery cell 10, and a vent barrier 133 formed to correspond to a vent of the battery cell 10. The first insulation member 130a may further include terminal barriers 131 and 132 respectively formed to correspond to terminals 11 and 12 of the battery cell 10. As the first insulation member 130a is an injection molding product, the main body part 134, the vent barrier 133, and the terminal barriers 131 and 132 are all integral with each other, i.e., a single and seamless unit formed simultaneously by injection molding of a same material.

The main body portion 134 may be implemented to correspond to the cap plate 14, so as to cover a top surface of the first insulation member 130a, i.e., to cover the cap plate 14. That is, as will be apparent to a person of ordinary skill in the art from the foregoing description and from the drawing, the main body portion 134 may completely cover, i.e., overlap, a top surface of the cap plate 14, with the exception of the openings in the cap plate 14.

The vent barrier 133 may be formed in a shape of a sidewall surrounding a periphery of the vent of the battery cell 10. The terminal barrier 131 or 132 may be formed in a shape of a sidewall surrounding a periphery of the terminal 11 or 12 of the battery cell 10. That is, as will be apparent to a person of ordinary skill in the art from the foregoing description and from the drawing, the vent barrier 133 and terminal barriers 131 and 132 may be sidewalls extending, e.g., perpendicularly, from the main body 134 in regions corresponding to the openings in the cap plate 14, i.e., to expose the openings in the cap plate 14. In this case, each of the vent barrier 133 and the terminal barriers 131 and 132 may be formed in the shape of a sidewall, and may protrude, e.g., upward, from the main body portion 134. The protruding direction may be the same as that of the terminals 11 and 12.

Meanwhile, the second insulation member 120 may be a single-faced or a double-faced insulation tape or an insulation tape of an insulation film. The second insulation member 120 may be formed on, e.g., directly on, sidewalls of the battery cell 10 to be adhered closely to the battery cell 10 (FIGS. 2 and 3A). For example, as will be apparent to a person of ordinary skill in the art from the foregoing description and from the drawing, the second insulation member 120 may extend continuously on all outer sidewalls of the battery cell 10, and may further extend to overlap side surfaces of the cap plate 14 and main body 134 of the first insulation member 130a. That is, referring to FIG. 3B, when the main body 134 and the cap plate 14 correspond in shape and size to a top of the battery cell 10 to have side surfaces of the main body 134, cap plate 14, and battery cell 10 aligned, the second insulation member 120 may extend continuously from the outer sidewall of the battery cell 10 onto, e.g., directly onto, the aligned side surfaces of the cap plate 14.

Referring to FIG. 3B, the battery module 100 according to the first embodiment may further include a third insulation member 130c interposed between the battery cell 10 and the second insulation member 120. For example, as will be apparent to a person of ordinary skill in the art from the foregoing description and from the drawing, the third insulation member 130c may continuously cover a bottom and lower portions of the sidewalls of the battery cell 10, so the third insulation member 130c and the second insulation member 120 may overlap each other at the lower portions of the sidewalls of the battery cell 10. Here, the third insulation member 130c covers a contact portion between bottom and side surfaces of the battery cell 10. The third insulation member 130 also covers the bottom surface of the battery cell 10. The third insulation member 130c may be formed of at least one of an insulation resin, an insulation film, and an insulation coating.

As such, the second insulation member 120, e.g., continuously, covers a contact portion, i.e., a contact surface, between the first insulation member 130 and the battery cell 10 at an upper portion of the battery cell 10, and covers a contact portion, i.e., a contact surface, between the third insulation member 130c and the battery cell 10. Accordingly, no disconnection section exists between the second insulation member 120 and the third insulation member 130c, penetration of moisture or foreign matter into the battery cell 10 may be prevented or substantially minimized, thereby avoiding reduction of insulation properties of the battery cell 10. Thus, a potential short circuit between the battery cell 10 and the battery module 100 may be prevented in advance. Here, the second insulation member 120 may be formed long to be disposed higher than the side surfaces of the main body portion 134, in consideration of assembling tolerance. Thus, when the second insulation member 120 is disposed on the side surfaces of the battery cell 10, it is possible to secure a design margin so that the second insulation member 120 can sufficiently cover the contact portion between the first insulation member 130a and the battery cell 10 at the upper portion of the battery cell 10, even when the second insulation member 120 surrounds the side surfaces of the first insulation member 130a in a state that the second insulation member 120 is slightly distorted.

The battery cell 10 may be manufactured by accommodating an electrode assembly and an electrolyte in a battery case, followed by sealing the battery case with the cap assembly 14. The cap assembly 14 may include positive and negative electrode terminals 11 and 12 respectively provided at both ends thereof, and a vent provided between the terminals 11 and 12. The electrode assembly may include a positive electrode plate, a negative electrode plate, and a separator interposed between the positive and negative electrode plates. The positive electrode plate is connected to the positive electrode terminal 11, and the negative electrode plate is connected to the negative electrode terminal 12, so that energy generated by an electrochemical reaction between the electrode assembly and the electrolyte is transferred to the outside of the battery cell 10. The vent serves as a passage through which gas generated inside the battery cell 10 is exhausted to the outside of the battery cell 10.

Referring to FIGS. 1 and 2, the plurality of battery cells 10 may be fixed by a pair of first and second end plates 111, side plates 112 and 113, and a bottom plate 114. Here, the first and second end plates 111 may be disposed at the outside of the battery cells 10, and the side plates 112 and 113 may connect the first and second end plates 111 to each other. The bottom plate 114 may be disposed on the bottom surfaces of the battery cells 10. Thus, the first and second end plates 111 and the side plates 112 and 113 may define a predetermined space to accommodate the plurality of battery cells 10 therein, and the battery cells 10 may be arranged in one direction in the defined space. In this case, the battery cells 10 may be arranged in parallel, so that wide surfaces of the battery cells 10 may face each other.

First ends of the side plates 112 and 113 and a first end of the bottom plate 114 may be fastened to the first end plate 111, and second ends of the side plates 112 and 113 and a second end of the bottom plate 114 may be fastened to the second end plate 111. Therefore, the first and second end plates 111 may be connected to each other. In this case, fastening of the end plates 111, side plates 112 and 113, and bottom plate 114 may be performed by, e.g., bolt-nut or the like, but embodiments are not limited thereto.

The first and second end plates 111 may be disposed to have surface contact with respective outermost battery cells 10, so as to apply pressure to the inside of the plurality of the battery cells 10. In this case, the plurality of battery cells 10 supported by the first and second end plates 111 may be arranged so that the positive and negative electrode terminals 11 and 12 are alternately disposed. Thus, adjacent terminals may be connected in series to each other. The side plates 112 and 113 may support opposite sides surfaces of the battery cells 10, and the bottom plate 114 may support bottom surfaces of the battery cells 10.

The positive and negative electrode terminals 11 and 12 of adjacent two battery cells 10 may be electrically connected to each other by a bus-bar 15. The bus-bar 15 may be provided with holes through which the positive and negative electrode terminals 11 and 12 pass, respectively. The bus-bar 15, by which the positive and negative electrode terminals 11 and 12 are connected to each other, may be fixed by a member, e.g., a nut 16.

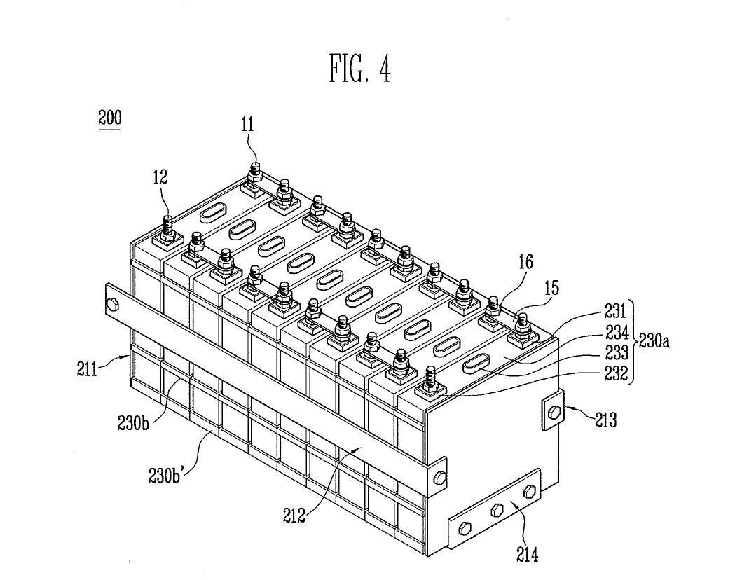

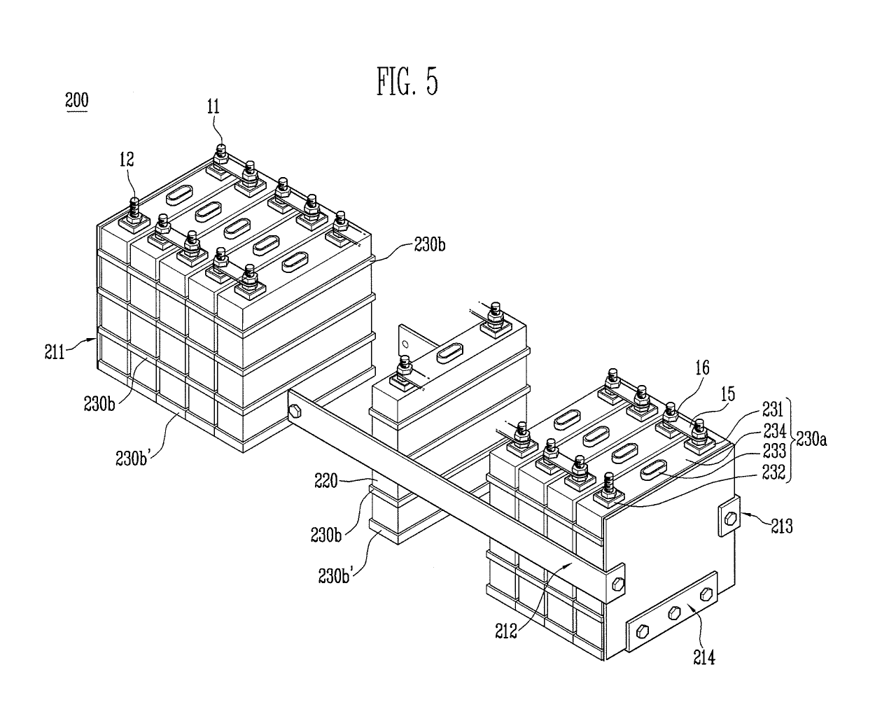

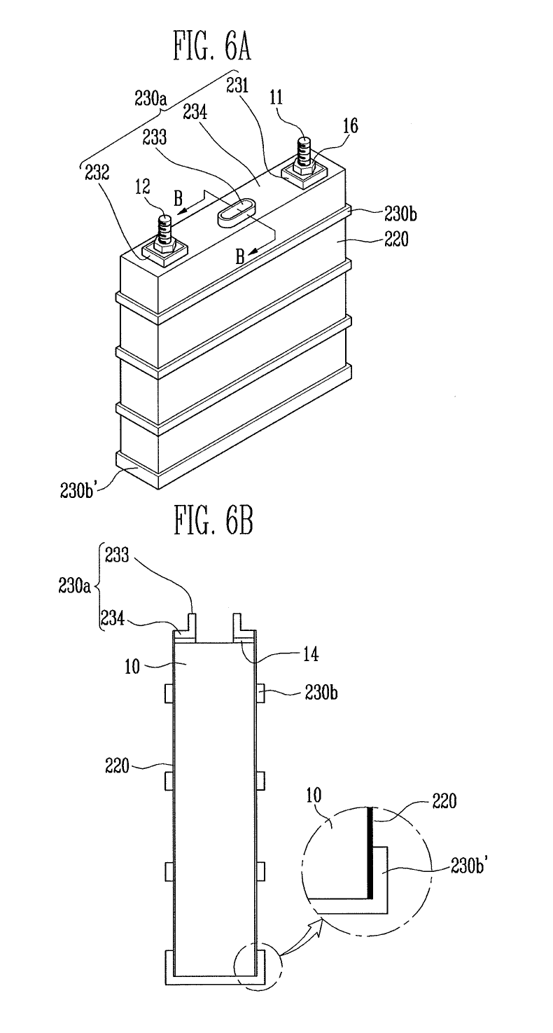

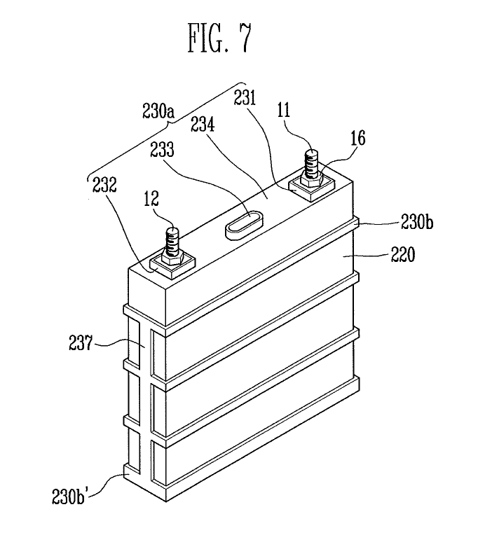

FIG. 4 is a perspective view schematically showing a battery module according to a second embodiment. FIG. 5 is an exploded perspective view of the battery module shown in FIG. 4. FIG. 6A is a perspective view of a battery cell shown in FIG. 5. FIG. 6B is a sectional view taken along line B-B of FIG. 6A. Meanwhile, FIG. 7 is a perspective view of a battery cell according to a third embodiment, which is a modification of the second embodiment. In the second and third embodiments, portions different from those in the first embodiment will be mainly described.

Referring to FIGS. 4-5, a battery module 200 according to the second embodiment may include the battery cells 10 with the cap plates 14 (FIG. 6B) provided on upper surfaces thereof, a first insulation member 230a covering the cap plate 14, and a second insulation member 220 covering side surfaces of the battery cell 10 and having at least one portion contacting the first insulation member 230a.

Like the first embodiment, the first insulation member 230a may be an injection molding product. In this case, the first insulation member 230a may be formed through insert-injection molding. Here, the first insulation member 230a may be formed at a temperature of about 250° C. or less. The first insulation member 230a is formed at the above temperature by injection molding is because heat having a melting temperature in injection molding is rapidly dissipated to the outside through a mold used in the injection molding, so the battery module 200 is not damaged due to the heat.

Here, like in the first embodiment, the first insulation member 230a may include a main body portion 234 formed to correspond to the battery cell 10, and a vent barrier 233 formed to correspond to a vent of the battery cell 10. The first insulation member 230a may further include terminal barriers 231 and 232 respectively formed to correspond to positive and negative terminals 11 and 12 of the battery cell 10. Further, as in the first embodiment, the second insulation member 220 may be a single-faced or a double-faced insulation tape or an insulation tape of an insulation film adhered closely to the battery cell 10.

Referring to FIGS. 6A and 6B, unlike the first embodiment, the battery module 200 according to the second embodiment may further include a fourth insulation member 230b on, e.g., directly on, the second insulation member 220. Here, the fourth insulation member 230b is an injection molding product that contacts the second insulation member 220. The fourth insulation member 230b may be formed in the shape of bands spaced apart from each other at a predetermined interval along the second insulation member 220, e.g., between the top and bottom surfaces of the battery cell 10. That is, the fourth insulation member 230b may be provided with at least one or more insulation members. The fourth insulation members 230b may be arranged in a longitudinal direction to be space apart from one another, and may be implemented to have a shape surrounding the circumference of the second insulation member 220.

The fourth insulation member 230b covers a contact portion between bottom and side surfaces of the battery cell 10, and includes a lower insulation member 230b′ provided on the second insulation member 220. In other words, as will be apparent to a person of ordinary skill in the art from the foregoing description and from the drawing, the lower insulation member 230b′ may completely cover the bottom of the battery cell 10, and may extend continuously from the bottom of the battery cell 10 to cover lower portions of the side surfaces of the battery cell 10. Therefore, a portion of the second insulation member may be between the lower insulation member 230b′ and the lower portions of the side surfaces of the battery cell 10.

As such, the second insulation member 220 covers a contact portion between the first insulation member 230a and the battery cell 10 at an upper portion of the battery cell 10, and is covered by being surrounded with the lower insulation member 230b′ at a lower portion of the battery cell 10, which is covered by the second insulation member 220. Accordingly, no discontinuous section exists between the second insulation member 230 and the fourth insulation member 230b including the lower insulation member 230b′. Therefore, penetration of moisture or foreign matter into the battery cell 10 may be prevented or substantially reduced, thereby improving the insulation properties of the battery cell 10. Thus, a potential short circuit between the battery cell 10 and the battery module 200 may be prevented in advance.

Also, the fourth insulation member 230b according to the second embodiment may serve as an existing barrier that forms an interval for insulation and heat dissipation between the battery cells 10. Here, the second insulation member 220 may be formed long to be disposed higher than the side surfaces of the main body portion 234, in consideration of assembling tolerance. Thus, when the second insulation member 220 is disposed on the side surfaces of the battery cell 10, it may be possible to secure a design margin so that the second insulation member 220 may sufficiently cover the contact portion between the first insulation member 230a and the battery cell 10 at the upper portion of the battery cell 10, even when the second insulation member 220 surround the side surfaces of the first insulation member 230a in a state that the second insulation member 220 is slightly distorted.

Meanwhile, referring to FIG. 7 that shows a modification of the second embodiment, the battery module according to the third embodiment may further include a band-shaped connecting portion 237 connecting a plurality of fourth insulation members 230b and the lower insulation member 230b′ to each other. The connecting portion 237 more firmly fixes the structure of the fourth insulation member 230b. Thus, the connecting portion 237 may substantially perform the function of a barrier of the fourth insulation member 230b.

Referring to FIGS. 4 and 6A, the plurality of battery cells 10 may be fixed by a pair of first and second end plates 211, side plates 212 and 213, and a bottom plate 214. Here, the first and second end plates 211 may be disposed at the outside of the battery cells 10, and the side plates 212 and 213 may connect the first and second end plates 211 to each other. The bottom plate 214 may be disposed on the bottom surfaces of the battery cells 10. Thus, the first and second end plates 211 and the side plates 212 and 213 may define a predetermined space to accommodate the plurality of battery cells 10 therein, and the battery cells 10 may be arranged in one direction in the defined space. In this case, the battery cells 10 are arranged in parallel so that wide surfaces of the battery cells 10 are opposite to each other. First ends of the side plates 212 and 213 and the bottom plate 214 may be fastened to the first end plate 211, and second ends of the side plates 212 and 213 and the bottom plate 214 may be fastened to the second end plate 211, so that the first and second end plates 211 may be connected to each other. In this case, the fastening may be performed by a bolt-nut or the like, but embodiments are not limited thereto.

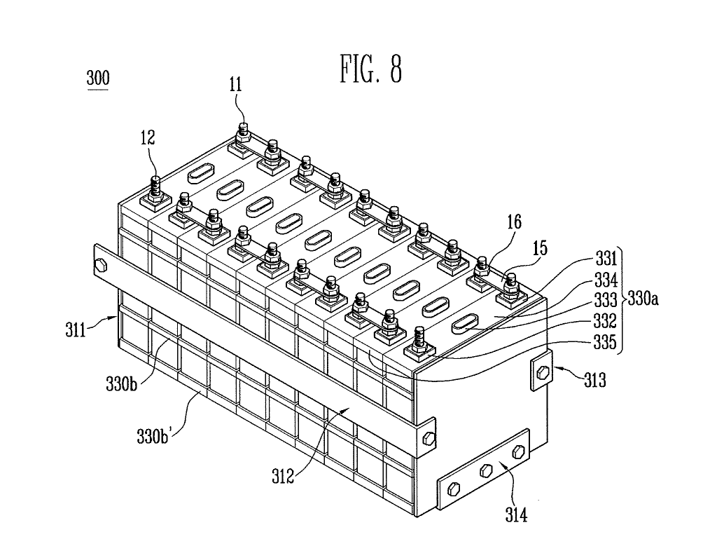

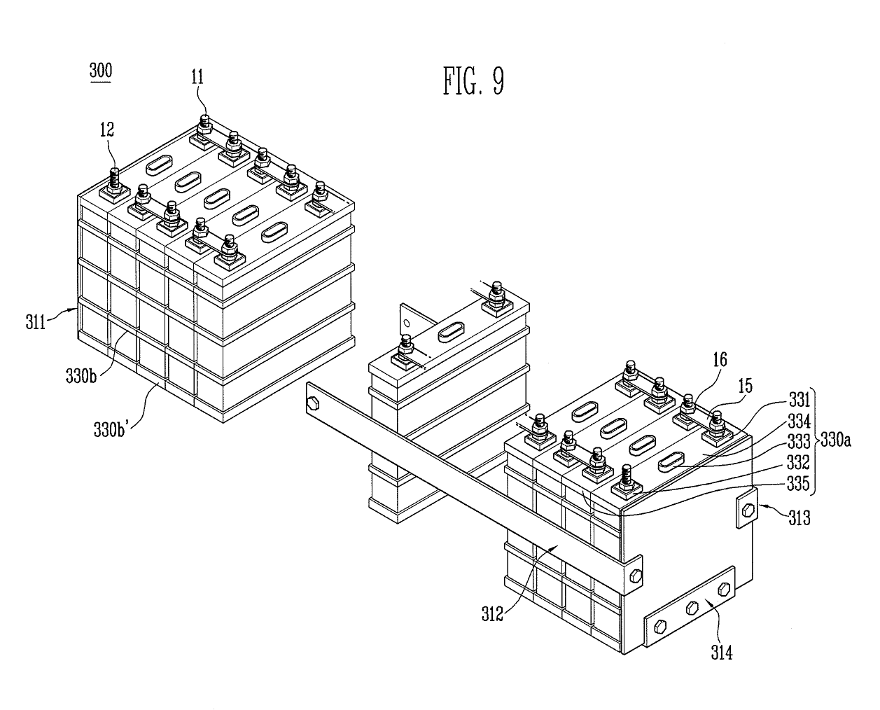

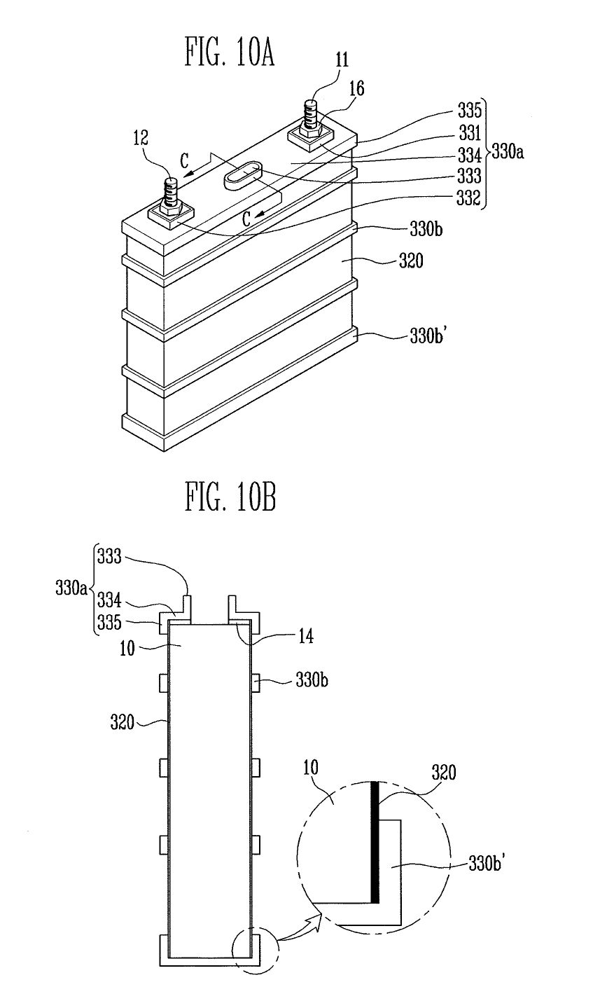

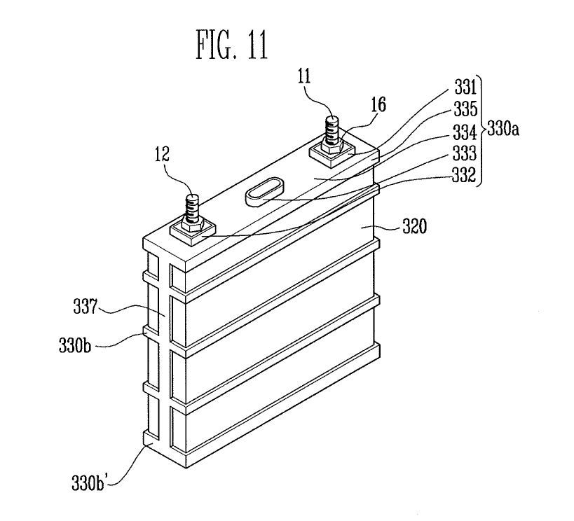

FIG. 8 is a perspective view schematically showing a battery module according to a fourth embodiment. FIG. 9 is an exploded perspective view of the battery module shown in FIG. 8. FIG. 10A is a perspective view of a battery cell shown in FIG. 9. FIG. 10B is a sectional view taken along line C-C of FIG. 10A. FIG. 11 is a perspective view of a battery cell according to a fifth embodiment. In the fourth and fifth embodiments, portions different from those in the first to third embodiments will be mainly described.

Referring to FIGS. 8 to 10A, a battery module 300 according to the fourth embodiment may include the battery cells 10, each having the cap plate 14 (FIG. 10B) provided on an upper surface thereof, a first insulation member 330a covering the cap plate 14, and a second insulation member 320 having at least one portion contacted with the first insulation member 330a, and covering the side surfaces of the battery cell 10.

Like the first embodiment, the first insulation member 330a may be an injection molding product. In this case, the first insulation member 330a may be formed through insert-injection molding. Here, the first insulation member 330a may be formed by insert-injection molding at a temperature of 250° C. or less, since heat having a melting temperature in injection molding is rapidly dissipated to the outside through a mold used in the injection molding, so the battery module 300 is not damaged due to the heat.

Here, like the first to third embodiments, the first insulation member 330a may include a main body portion 334 formed to correspond to the battery cell 10, and a vent barrier 333 formed to correspond to a vent of the battery cell 10. The first insulation member 330a may further include terminal barriers 331 and 332 respectively formed to correspond to the terminals 11 and 12 of the battery cell 10. Further, like the first to third embodiments, the second insulation member 320 may be a single-faced or a double-faced insulation tape or an insulation tape of an insulation film. The second insulation member 320 may be formed to be adhered closely to the battery cell 10.

Referring to FIGS. 10A and 10B, like the second and third embodiments, the battery module 300 according to the fourth embodiment may further include a fourth insulation member 330b on the second insulation member 320. Here, the fourth insulation member 330b is an injection molding product that contacts the second insulation member 320 and is provided in the shape of bands spaced apart from each other at a predetermined interval between the second insulation member 320 and the bottom surface of the battery cell 10. The fourth insulation member 330b covers a contact portion between bottom and side surfaces of the battery cell 10, and includes a lower insulation member 330b′ provided on the second insulation member 320.

Unlike the first to third embodiments, in the battery module 300 according to the fourth embodiment, the first insulation member 330a further includes an extending portion 335 formed to extend from the main body portion 334 of the first insulation member 330a to the side surfaces of the battery cell 10 so as to contact the second insulation member 320. As such, the second insulation member 230 may be covered by being surrounded with the extending portion 335 at an upper portion of the battery cell 10, and is covered by being surrounded with the lower insulation member 330b′ at a lower portion of the battery cell 10, which is covered by the second insulation member 320. Accordingly, no discontinuous section exists between the second insulation member 330 and the fourth insulation member 330b including the lower insulation member 330b′. Therefore, penetration of moisture or foreign matter into the battery cell 10 may be minimized or substantially prevented, so insulation properties of the battery cell 10 may be improved. Thus, a potential short circuit between the battery cell 10 and the battery module 300 may be prevented in advance. Further, the first insulation member 330a further including the extending portion 335 and the fourth insulation member 330b according to the fourth embodiment may serve as an existing barrier that forms an interval for insulation and dissipation between the battery cells 10.

Meanwhile, referring to FIG. 11 that shows a modification of the fourth embodiment, a battery module according to the fifth embodiment may further include a band-shaped connecting portion 337 connecting the fourth insulation members 330b and the lower insulation member 330b′ to each other. The connecting portion 337 more firmly fixes the structure of the fourth insulation member 330b. Thus, the connecting portion 337 may substantially perform the function of a barrier of the fourth insulation member 330b.

Referring to FIGS. 8 and 10A, the plurality of battery cells 10 may be fixed by a pair of first and second end plates 311, side plates 312 and 313, and a bottom plate 314. Here, the first and second end plates 311 may be disposed at the outside of the battery cells 10, and the side plates 312 and 313 may connect the first and second end plates 311 to each other. The bottom plate 314 may be disposed on the bottom surfaces of the battery cells 10. Thus, the first and second end plates 311 and the side plates 312 and 313 may define a predetermined space to accommodate the plurality of battery cells 10 therein, and the battery cells 10 may be arranged in one direction in the defined space. In this case, the battery cells 10 may be arranged in parallel so that wide surfaces of the battery cells 10 are opposite to each other. First ends of the side plates 312 and 313 and the bottom plate 314 may be fastened to the first end plate 211, and second ends of the side plates 312 and 313 and the bottom plate 314 may be fastened to the second end plate 311, so that the first and second end plates 311 may be connected to each other. In this case, the fastening may be performed by a bolt-nut or the like, but example embodiments are not limited thereto.

As described above, according to embodiments, an insulation member of a battery cell may be formed to include overlapping sections of insulating members. Therefore, exposed surfaces and/or portions of the battery cell may be substantially minimized. As such, penetration of moisture or foreign matter into the battery cell may be prevented or substantially minimized, thereby improving insulation of the battery cell. Also, a potential short circuit between the battery cell and the battery module may be prevented. Further, an insulation member having improved assembly efficiency may be applied to the battery cell, so that processing efficiency and reduced production costs may be provided.

In contrast, a conventional insulation member between battery cells may include a discontinuous section exposing a portion of the battery assembly, so moisture or foreign matter may penetrate through the discontinuous section. As such, the insulation characteristic of the conventional insulation member may be lowered. For example, a short circuit between a can of the battery cell and a metal frame of the battery module may occur due to dew condensation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells, each battery cell including a cap plate on an upper surface thereof;
a first insulation member covering the cap plate; and
a second insulation member covering side surfaces of the battery cell, the second insulation member having at least one portion contacting the first insulation member.

2. The battery module as claimed in claim 1, wherein the entire first insulation member is an injection molding product.

3. The battery module as claimed in claim 2, wherein the injection molding product is a seamless, integral unit.

4. The battery module as claimed in claim 1, wherein the first insulation member includes:
a main body portion corresponding to the cap plate of the battery cell; and
a vent barrier corresponding to a vent of the battery cell.

5. The battery module as claimed in claim 4, wherein the first insulation member further comprises a terminal barrier corresponding to a terminal of the battery cell.

6. The battery module as claimed in claim 4, wherein the second insulation member extends higher than a height of side surfaces of the main body portion.

7. The battery module as claimed in claim 4, wherein the first insulation member further comprises an extending portion, the extending portion extending from the main body portion toward side surfaces of the battery cell and contacting the second insulation member.

8. The battery module as claimed in claim 1, wherein the second insulation member is a single-faced insulation tape, a double-faced insulation tape, or an insulation film.

9. The battery module as claimed in claim 1, further comprising a third insulation member covering at least one contact portion between bottom and side surfaces of the battery cell, the third insulation member being between the battery cell and the second insulation member.

10. The battery module as claimed in claim 9, wherein the third insulation member covers the bottom surface of the battery cell.

11. The battery module as claimed in claim 9, wherein the third insulation member includes at least one of an insulation resin, an insulation film, and an insulation coating.

12. The battery module as claimed in claim 1, further comprising one or more fourth insulation members on the second insulation member, the fourth insulation member being between the second insulation member and a bottom surface of the battery cell.

13. The battery module as claimed in claim 12, wherein the fourth insulation member includes a lower insulation member covering a contact portion between bottom and side surfaces of the battery cell, the lower insulation member being on the second insulation member.

14. The battery module as claimed in claim 12, wherein the fourth insulation member includes a plurality of members spaced apart from each other at a predetermined interval, a connecting portion connecting the plurality of fourth insulation members.

15. The battery module as claimed in claim 12, wherein the fourth insulation member surrounds the second insulation member.

16. The battery module as claimed in claim 1, wherein the second insulation member extends continuously beyond side surfaces of the battery cell to overlap first insulation member on the cap plate.

17. The battery module as claimed in claim 16, wherein the second insulation member overlaps a side surface of the cap plate and a side surface of the first insulation member.
